(19) United States
(12) Patent Application Publication
(10) Pub. No.: US 2002/0107808 A1
(43) Pub. Date: Aug. 8, 2002

(54) Arrangement, facilitating device, first user device and method

(76) Inventor: Astrid Mathilda Ferdinanda Dobbelaar, Eindhoven (NL)

Correspondence Address: U.S. Philips Corporation, 580 White Plains Road, Tarrytown, NY, 10591, US

(21) Appl. No.: 10/047,026

(22) Filed: Jan. 15, 2002

(30) Foreign Application Priority Data
Jan. 18, 2001 (EP) 01200173.1

(51) Int. Cl. G06F 17/60

(52) U.S. Cl. 705/52; 705/1

(57) ABSTRACT

An arrangement (100) for facilitating the sharing of a content item (101), comprising a first user device (110), a facilitating device (120) and a second user device (130). The arrangement (100) realizes a method of facilitating the sharing of a content item (101), comprising receiving from the first user device (110) an identifier for the content item (101) and an identifier for the second user device (130), generating a representation (102) for the content item (101), and transmitting the representation (102) to the second user device (130). Also a computer program product (140).

The invention relates to an arrangement for facilitating the sharing of a content item, and to a facilitating device and a first user device for use in such an arrangement.

The invention further relates to a method of facilitating the sharing of a content item.

The invention further relates to a computer program product.

In the exponentially growing world of broadcasted audiovisual content, the chance that two people see or hear the same content item becomes smaller and smaller. And if one person, while watching, thinks it would be nice if another person were to see the same content item, it will not be easy for him or her to realize this. Once the content item is being played, it is too late to start a recording which can be sent to that other person. It is very time-consuming and tedious for a person to obtain a copy on tape from the broadcasting organization, and very costly and labor-intensive for the broadcasting organization itself.

Even when a person does have a recording of the content item, it is not easy for him to quickly show it to another person. He would have to make a selection of representative moments in the playback of the content item, which is not easy to do with most consumer equipment. Further, copyright law puts restrictions on what one person may share from a content item with other persons.

It is an object of the invention to provide an arrangement for facilitating the sharing of a content item, which is easy to use.

This object is achieved according to the invention in an arrangement as claimed in claim 1. A user selects a content item which he wants to share with another user.

He then selects an identifier for the other user, and sends the necessary information to the facilitating device, which generates a representation for the content item and forwards it to the other user. The user does not have to do anything other than selecting the content item and the user with whom he wants to share it. The facilitating device takes care of all the necessary details, making the process as transparent as possible. The other user can examine the representation and decide whether he likes the content item or not.

It is a further object of the invention to provide a facilitating device for use with such an arrangement, which facilitates such an easy to use arrangement.

This object is achieved according to the invention in a facilitating device comprising receiving means for receiving from a first user device an identifier for the content item and an identifier for a second user device, generating means for generating a representation for the content item, and transmitting means for transmitting the representation to the second user device. As explained above, the first user device only needs to submit the necessary information to the facilitating device. It is the facilitating device that performs all the time-consuming activities, such as generating the representation for the content item and forwarding it to another user device, which may not even be active when the user of the first user device decides to share the content item.

In an embodiment the facilitating device further comprises electronic payment receiving means for receiving an electronic payment from the first user device. The provider of the service realized by this facilitating device may want to charge for the service of facilitating the sharing of the content item. Electronic payment schemes have the advantage that they are quick, unobtrusive and allow payment in very small quantities (micropayments). This makes it much more likely that a user is willing to pay for the use of the service than when a traditional, credit card- or subscription-based payment scheme is employed. This embodiment also has the advantage that the electronic payment can also be used to pay the royalties that are due to the copyright owners whose materials are used by this service. This will encourage copyright owners to allow the sharing of their content items using this service.

In another embodiment the facilitating device further comprises relating means for generating at least one reference to a further content item related to the content item, whereby the generating means are arranged for adding the at least one reference to the representation. It is advantageous from a business point of view for the operator of the facilitating device to charge owners of the further content items for adding a reference thereto to the representation. These references will get a high level of exposure, since they accompany something that was sent to the recipient by a friend or acquaintance. When they are related to the content item, their exposure is even higher, since the recipient is interested in the content item and therefore also in related items.

It is a further object of the invention to provide a method of facilitating the sharing of a content item, which is easy to use.

This object is achieved according to the invention in a method as claimed in claim 6. Using this method, users can select a content item which they want to share with another user. They then send identifiers for the content item and the other user to a facilitator, which generates a representation for the content item and forwards it to the other user. The user does not have to do anything other than selecting the content item and the user with whom they want to share it. The facilitator takes care of all the necessary details, making the process as transparent as possible. The recipient gets a message with a representation and possibly a personalized message from the sender, and can easily view it and decide to view the entire content item if that wasn't included in the message.

In an embodiment the method further comprises receiving an electronic payment from the first user device. The provider of this service may want to charge for the service of facilitating the sharing of the content item. Electronic payment schemes have the advantage that they are quick, unobtrusive and allow payment in very small quantities (micropayments). This makes it much more likely that a user is willing to pay for the use of the method than when a traditional, credit card- or subscription-based payment scheme is employed.

These and other aspects of the invention will be apparent from and elucidated with reference to the embodiments shown in the drawing, in which:

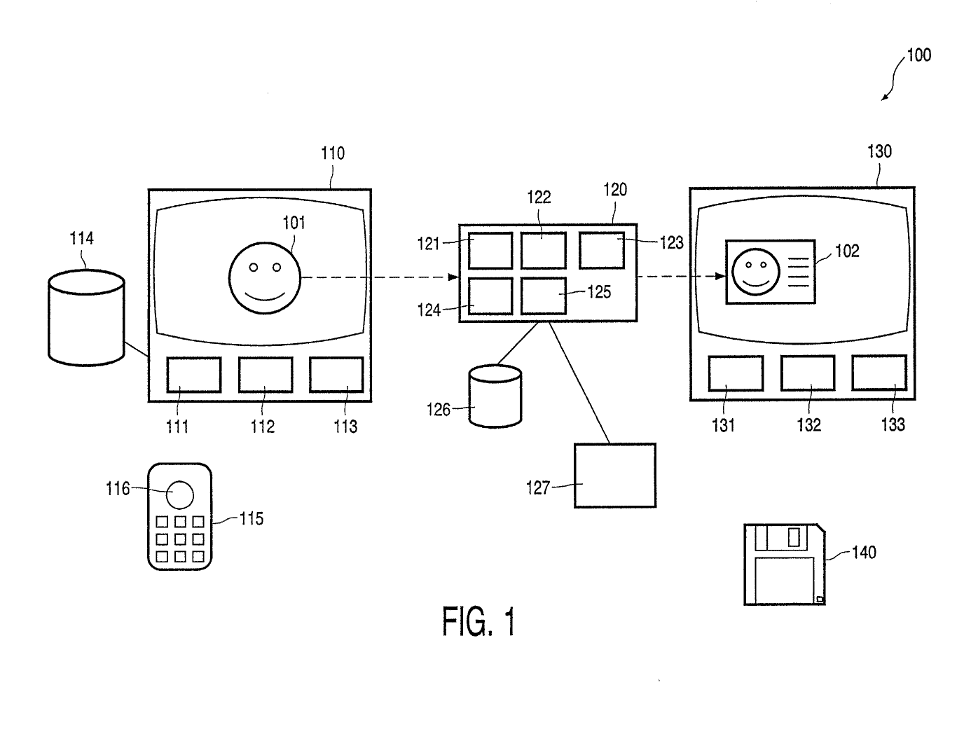

FIG. 1 schematically shows an arrangement comprising a first user device, a facilitating device and a second user device according to the invention; and

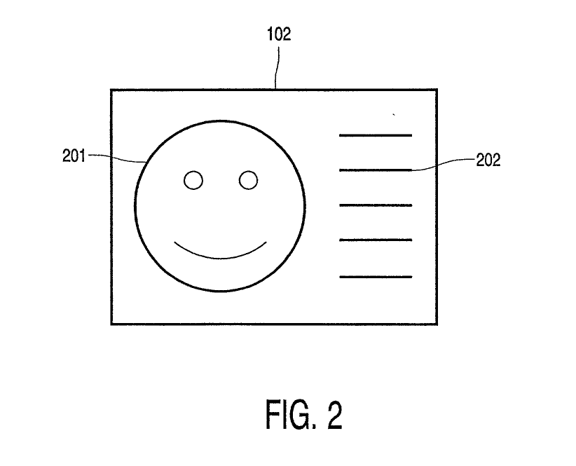

FIG. 2 schematically shows a representation of a content item.

Throughout the figures, same reference numerals indicate similar or corresponding features. Some of the features indicated in the drawings are typically implemented in software, and as such represent software entities, such as software modules or objects.

FIG. 1 schematically shows an arrangement 100 for facilitating the sharing of a content item 101. The arrangement 100 comprises a first user device 110, a facilitating device 120 and a second user device 130.

The first user device 110 is a device such as a digital television or set-top-box receiver, which can receive content items such as television programs or movies and present them, possibly with the aid of a separate rendering device, to a user. The content items may be loaded from storage, such as memory 114, or be obtained from some external source (not shown). The first user device 110 may be arranged for receiving a content item from the external source and recording it on the memory 114 for later viewing. The user may use a remote control 115 or other input device to control the operation of the first user device 110.

Since there is a very large amount of content items available for viewing, and this amount will only increase in the near future, the first user device 110 may need to employ some filtering mechanism to allow the user to view only those content items he likes. This filtering mechanism could for instance automatically record any content item that fits a user profile for the user, so that the user can view those content items at the time and in the order he desires. This means that a number of recorded content items can be present in the memory 114.

When the user, through filtering, flipping channels, browsing the memory 114 or some other means, finds the content item 101, which he likes, he may decide that he would like to share this content item 101 with another user. To this end, the first user device 110 comprises a content item selector 116, which can for instance be realized as a button on the remote control 115, or as a ‘soft key’ on the display of the first user device 110. The user uses this selector 116 to indicate his desire to share the content item presently being viewed.

When the user uses the selector 116, an identifier for the content item 101 needs to be obtained. To this end, a selecting module 111 is provided. The selecting module 111 can obtain the identifier in various ways. The identifier may be present in metadata accompanying the content item 101, or be embedded as a watermark in the content item 101. It may also be derived from, for instance, the date, time and channel that the user was watching when he used the selector 116. This information is usually sufficient to determine which content item he was watching.

Further, the user needs to identify the other user with whom he wants to share the content item 101. There are various ways in which this can be realized. From e-mail programs it is well known to provide an electronic address books, which contain a collection of names and e-mail addresses for users. Such a name and e-mail address can serve as an identifier for the other user. The selecting module 111 is preferably provided with an electronic address book from which the user can select an identifier for the other user with whom he wants to share the content item 101. Alternatively, it may provide access to an electronic directory service through which the other user can be located. The user may, as a last resort, be asked to manually type in an identifier, such as a name, of the other user.

The identifier, whether obtained from an electronic address book, through manual entry or by some other means, is to be used to locate the other user to inform him that someone wants to share the content item 101 with him. It is therefore desirable that the identifier comprises an indication for the second user device 130, which is the device used by the other user.

The selecting module 111 then passes the identifier for the content item 101 and the identifier for the second user device 130 to a transmitting module 112 which transmits them to the facilitating device 120. The user may optionally add a personal message for the other user to this transmission.

With just the identifier for the content item 101, the other user can determine which content item 101 was referred to. This may enable him to access more information on this content item 101, or view it himself if it is still being played. If the content item 101 is broadcast regularly, for example if it is an episode of a series, the recipient can use the identifier to access the next episode.

However, if the content item 101 has been stored on memory 114, it becomes possible to not just send an identifier for the content item 101, but also at least a portion of the content item 101 itself. This allows the recipient to directly view the content item 101, even when it was a one-time broadcast. In that case, the selecting module 111 additionally passes the portion of the content item 101 to the transmitting module 112, which sends it together with the identifier for the content item 101 and the identifier for the second user device 130 to the facilitating device 120.

The facilitating device 120 comprises a receiving module 121 which receives the identifier for the content item 101, the identifier for the second user device 130 and optionally a portion of the content item 101. The transmission from the first user device 110 to the facilitating device 120 takes place over a network of some sort, preferably the Internet. A direct dial-up connection to the facilitating device 120 may also be used.

A generating module 122 generates a representation 102 for the content item 101. This representation 102 is what the other user will see on the second user device 130. The objective in generating the representation 102 is to allow the other user to quickly examine what the content item 101 is about. The representation 102 can be generated by taking some representative still images or one or more fragments from the content item 101.

Preferably, the generating module 122 generates the representation 102 by including a ‘teaser’ or promotional message. This way, the other user will be encouraged to obtain his own copy of the content item 101. Such teasers are often readily available, and may be provided in memory 126. The identifier for the content item 101 can be used to look up this teaser in the memory 126.

Alternatively, the representation 102 may be generated based on at least a portion of the content item 101 itself. The generating module 122 may extract key frames from the portion, or from the whole content item 101, and compile them together to generate the representation 102. The content item 101, or the portion of it, can be obtained from memory 126 or from some external source. It may also be present in the transmission that was received from the first user device 110. If the content item 101 was not present in that transmission, the generating module 122 may retrieve it from some other source and include it in whole or in part, so as to facilitate that the intended recipient can view it.

The representation 102 can be further enhanced by adding at least one reference to a further content item to it. To this end, a relating module 125 generates at least one reference to a further content item, which is preferably related to the content item 101. This is explained in more detail with reference to FIG. 2 below.

After the relating module 125 has generated the at least one reference, the generating module 122 adds the at least one reference to the representation 102. Any personal message added by the user of the first user device 110 is added as well. It may be desirable to also include an identifier for the user of the first user device 110, so that the recipient knows who sent him this representation 102. A retransmitting module 123 then transmits the representation 102 to the second user device 130.

The second user device 130 comprises a receiving module 131 which receives the representation 102. A rendering module 132 can present the representation 102 to the other user, for instance in the form of an electronic ‘postcard’ showing the representation 102, any references that were included with it, as well as the personal message, if present.

The second user device 130 may comprise a user profile maintenance module 133, which maintains a user profile for the other user. The other user can now be asked to rate the content item 101 represented by this representation 102. This rating is then added to the user profile, and is of high value since the other user actively viewed the content item 101. Alternatively, the user profile maintenance module 133 may give a high rating to the content item 101 based on the fact that it was forwarded to the other user by a friend, which indicates that it is most likely of interest to him. The other user may want to adjust the height of this rating depending on his evaluation of taste of this friend, though.

The operator of the facilitating device 120 may want to charge for the service of facilitating the sharing of the content item 101. To this end, the facilitating device 120 is provided with an electronic payment receiving module 124 for receiving an electronic payment from the first user device 110. The first user device 110 then needs to be provided with electronic payment sending module 113 for sending an electronic payment to the facilitating device 120.

The electronic payment sending module 113 in the first user device 110 can then send a payment to the electronic payment receiving module 124. The electronic payment receiving module 124 may need to verify the electronic payment with a trusted third party, such as electronic bank 127, to guard against fraud and double spending.

The electronic payment may comprise a credit card number or an authorization to withdraw a certain amount from the user's bank account. The amount that needs to be withdrawn depends on the nature of the service that is provided, which in turn depends at least in part on the amount of data that is received from the first user device 110. When only the identifier for the content item 101 is received, the representation 102 will be a recommendation for that content item 101. Such a service should cost very little, so that the user will not be discouraged by the costs from using the service. In that case, it is preferably to use a micropayment scheme. Such a micropayment is typically a few cents, or even less. It is typically realized using a cryptographic scheme. The service operator can make a profit if enough people use the service.

If the whole content item 101 is to be retransmitted to the second user device 130, then a somewhat larger amount may be charged. The service now allows one user to “give a TV program as a gift”, or in general share a content item with another user. Users will be willing to pay more for such a service.

However, incorporating a content item 101, or a substantial portion of it, in the representation 102 may be a copyright violation, depending on local law. This means that royalties are due to the copyright holder for the content item 101. The operator of the facilitating device 110 can work out a suitable recompensation scheme with copyright owners or copyright clearinghouses, and then employ the electronic payment arrangement as outlined above to obtain the compensation from users of his service.

The facilitating device 120 can be realized as a computer program product 140 being arranged for causing a processor to execute the method according to the invention. The computer program product 140 enables a programmable device when executing said computer program product to function as the facilitating device 120.

FIG. 2 schematically shows the representation 102 of the content item 101 in more detail. It is embodied here as an electronic ‘postcard’, showing a still image 201 taken from the content item 101. This still image 201 is representative for the content item 101. This ensures that the recipient of the representation 102 immediately knows what the content item 101 is about and enables him to decide whether he likes it or not.

Several references 202 have been added to the representation 102. They are preferably related to the content item 101. This way, they are highly likely to be accessed by the other user.

For instance, if the content item 101 is a movie, references 202 to an electronic store where the DVD for the movie or the CD with the soundtrack can be bought can be added. If the content item 101 is a performance of a music group, the references 202 may point to their fanclub or to a service where tickets for their next performance can be bought.

Preferably, the references 202 are realized as hyperlinks to resources on the Internet. It makes sense from a business point of view for the operator of the facilitating device 120 to charge owners of the further content items for adding a reference thereto to the representation 102. These references will get a high level of exposure, since they accompany something that was sent to the recipient by a friend or acquaintance.

1. An arrangement (100) for facilitating the sharing of a content item (101), comprising a first user device (110), a facilitating device (120) and a second user device (130),
the first user device (110) comprising selecting means (111) for obtaining an identifier for the content item (101) and an identifier for the second user device (130), and transmitting means (112) for transmitting the identifier for the content item (101) and the identifier for the second user device (130) to the facilitating device (120), and
the facilitating device (120) comprising receiving means (121) for receiving from the first user device (110) the identifier for the content item (101) and the identifier for the second user device (130), generating means (122) for generating a representation (102) for the content item (101), and retransmitting means (123) for transmitting the representation (102) to the second user device (130).

2. A facilitating device (120) for use in the arrangement (100) of claim 1, the facilitating device (120) comprising receiving means (121) for receiving from a first user device (110) an identifier for the content item (101) and an identifier for a second user device (130), generating means (122) for generating a representation (102) for the content item (101), and transmitting means (123) for transmitting the representation (102) to the second user device (130).

3. The facilitating device (120) of claim 2, further comprising electronic payment receiving means (124) for receiving an electronic payment from the first user device (110).

4. The facilitating device (120) of claim 2 or 3, further comprising relating means (125) for generating at least one reference (202) to a further content item (101) related to the content item (101), whereby the generating means (122) are arranged for adding the at least one reference (202) to the representation (102).

5. A first user device (110) for use in the arrangement (100) of claim 1, the first user device (110) comprising selecting means (111) for obtaining an identifier for the content item (101) and an identifier for a second user device (130), and transmitting means (112) for transmitting the identifier for the content item (101) and the identifier for the second user device (130) to a facilitating device (120).

6. A method of facilitating the sharing of a content item (101), comprising receiving from a first user device (110) an identifier for the content item (101) and an identifier for a second user device (130), generating a representation (102) for the content item (101), and transmitting the representation (102) to the second user device (130).

7. The method of claim 6, further comprising receiving an electronic payment from the first user device (110).

8. The method of claim 6 or 7, where the representation (102) is a promotional message for the content item (101).

9. The method of claim 6 or 7, further comprising generating at least one reference (202) to a related content item (101) and adding the at least one reference (202) to the representation (102).

10. A computer program product (140) being arranged for causing a processor to execute the method of claim 6.
